(19) United States
(12) Patent Application Publication
(10) Pub. No.: US 2012/0051206 A1
(43) Pub. Date: Mar. 1, 2012

(54) OBJECTIVE LENS, LENS MANUFACTURING METHOD, AND OPTICAL DRIVE APPARATUS

(75) Inventors: Kazuhiko Fujiie, Kanagawa (JP); Koji Sekiguchi, Kanagawa (JP)

(73) Assignee: SONY CORPORATION, Tokyo (JP)

(21) Appl. No.: 13/212,647

(22) Filed: Aug. 18, 2011

(30) Foreign Application Priority Data
Aug. 25, 2010 (JP) 2010-187992

(51) Int. Cl. G11B 7/00; G02C 7/02; G02B 3/00

(52) U.S. Cl. 369/112.23; 359/664; 156/99; G9B/7

(57) ABSTRACT

An objective lens includes: a solid immersion lens having a super-hemispherical or hemispherical shape, wherein a hyper-lens portion is formed in a part of an object-side surface of the solid immersion lens and integrated therewith by alternately stacking a first thin film having a positive dielectric constant and a second thin film having a negative dielectric constant along spherical shapes starting from a spherical shape having a radius Ri around a predetermined reference point Pr set outside the object-side surface of the solid immersion lens to a spherical surface having a radius Ro (Ro>Ri) around the reference point Pr.

### FIELD

The present disclosure relates to an objective lens including a solid-immersion lens and a method for manufacturing the solid-immersion lens. The present disclosure also relates to an optical drive apparatus that includes the objective lens and records information on an optical recording medium or reproduces information recorded on the optical recording medium.

### BACKGROUND

As an optical recording medium to and/or from which information is recorded and/or recorded information is reproduced by irradiating the optical recording medium with light, what is called an optical disc recording medium (also simply called an optical disc), such as a CD (compact disc), a DVD (digital versatile disc), and a BD (Blu-ray® disc), has been widely used.

In development of the optical discs described above, progressive efforts have been made to shorten the wavelength of recording/reproduction light and increase the numerical aperture (NA) of an objective lens so that the size of a focused spot of light used to record/reproduce information becomes smaller and recording capacity and recording density become higher.

Any of the optical discs of related art, however, has been known to have a limitation in increasing the numerical aperture NA, on which the size (diameter) of the focused light spot depends, to be greater than “one” because the medium between the objective lens and the optical disc is air.

Specifically, the size of a spot of light focused on an optical disc through an objective lens is approximately given by the following expression:

λ/NA_{obj}

where NA_{obj} represents the numerical aperture of the objective lens and λ represents the wavelength of the light.

The numerical aperture NA_{obj} is expressed by the following equation:

NA_{obj}=n_{A}×sin θ

where n_{A} represents the refractive index of the medium interposed between the objective lens and the optical disc, and θ represents the angle of incidence of a light ray passing through the periphery of the objective lens.

As will be understood by examining the expression, NA_{obj} cannot be greater than one as long as the medium is air (n_{A}=1).

To circumvent the limitation, JP-A-2010-33688, JP-A-2009-134780, and other documents disclose and propose recording/reproducing methods in which NA_{obj}>1 is achieved by using near-field light (evanescent light) (near-field recording/reproducing method).

As well known, information is recorded/reproduced in the near-field recording/reproducing method by irradiating an optical disc with near-field light. In this process, a solid-immersion lens (hereinafter abbreviated to SIL) is used as an objective lens through which the optical disc is irradiated with near-field light (see JP-A-2010-33688 and JP-A-2009-134780, for example).

FIG. 12 describes a SIL-based near-field optical system of related art.

FIG. 12 shows an example in which a SIL shaped into a super-hemisphere (super-hemispherical SIL) is used as the SIL. Specifically, the super-hemispherical SIL in this case has an object-side flat surface (that is, the surface facing a recording medium to and from which information is recorded and reproduced) and the remaining super-hemispherical surface.

The objective lens in this case is formed of a group of two lenses, one of which is a front lens formed of the super-hemispherical SIL described above. As shown in FIG. 12, a rear lens is a bi-aspheric lens.

An effective numerical aperture NA of the objective lens having the configuration shown in FIG. 12 is expressed as follows:

NA=n_{SIL}²×sin θi

where θi represents the angle of incidence of incident light, and n_{SIL} represents the refractive index of the material with which the super-hemispherical SIL is made.

The expression indicates that the effective numerical aperture NA of the objective lens having the configuration shown in FIG. 12 can be greater than “one” by setting the refractive index n_{SIL} of the SIL at a value greater than “one” (greater than the refractive index of air).

In related art, the refractive index n_{SIL} of a SIL has been set, for example, at approximately 2, based on which an effective numerical aperture NA of approximately 1.8 has been achieved.

A near-field optical system does not necessarily have a configuration using such a super-hemispherical SIL but may have a configuration using a SIL having a hemispherical shape (hemispherical SIL).

When an objective lens includes a hemispherical SIL instead of the super-hemispherical SIL shown in FIG. 12, the effective numerical aperture NA of the objective les is expressed as follows:

NA=n_{SIL}×sin θi

The expression indicates that using a hemispherical SIL still allows the NA to be greater than one by using a high refractive index material (n_{SIL}>1) as the material with which the SIL is made.

Comparing the expression for a super-hemispherical SIL with the expression for a hemispherical SIL indicates that using a super-hemispherical SIL can provide a higher effective NA when the super-hemispherical SIL and the hemispherical SIL are made of the same material (materials having the same refractive index).

For confirmation purposes, to record/reproduce information by using a SIL to produce light having a numerical aperture greater than one (near-field light) and allow the light to propagate to a recording medium (irradiate a recording medium with the near-field light), the object-side surface of the SIL needs to be proximate to the recording medium. The space between the object-side surface of the SIL and the recording medium (recording surface) is called a gap.

In a near-field recording/reproducing method, the gap needs to be at least approximately one-fourth the wavelength of light in use or smaller.

### SUMMARY

As described above, using an objective lens including a hemispherical or super-hemispherical SIL allows the numerical aperture NA to be greater than “one” and hence the spot diameter to be reduced to a value smaller than the limit imposed by an optical disc system of related art. That is, the recording density and hence the recording capacity can be increased accordingly.

It can be said that higher recording density and higher recording capacity are typically preferable and there is a demand to further increase them.

Thus, and it is desirable to achieve a higher effective numerical aperture NA than that of an objective lens using a SIL of related art to further increase the recording density and the recording capacity.

An embodiment of the present disclosure is directed to an objective lens configured as follows.

That is, an objective lens according to the embodiment of the present disclosure includes a solid immersion lens having a super-hemispherical or hemispherical shape.

The solid immersion lens has a hyper-lens portion formed in a part of an object-side surface thereof and integrated therewith by alternately stacking a first thin film having a positive dielectric constant and a second thin film having a negative dielectric constant along spherical shapes starting from a spherical shape having a radius Ri around a predetermined reference point Pr set outside the object-side surface of the solid immersion lens to a spherical surface having a radius Ro (Ro>Ri) around the reference point Pr.

Another embodiment of the present disclosure is directed to the following first and second methods as a method for manufacturing a solid immersion lens accommodated in the objective lens according to the above embodiment of the present disclosure.

That is, the first lens manufacturing method includes: forming a recess in an object-side surface of a solid immersion lens having a super-hemispherical or hemispherical shape, the recess having the same shape as that of a part of a spherical surface having a predetermined radius Ro, and alternately stacking a first thin film having a positive dielectric constant and a second thin film having a negative dielectric constant in the recess formed in the forming along the shape of the recess.

The second lens manufacturing method includes: preparing a substrate having a protrusion formed thereon, the protrusion having the same surface shape as that of a part of a spherical surface having a predetermined radius Ri, and alternately stacking a first thin film having a positive dielectric constant and a second thin film having a negative dielectric constant over the protrusion along the shape thereof.

The second lens manufacturing method further includes bonding a solid immersion lens having a super-hemispherical or hemispherical shape to a substrate with a high refractive index adhesive in a state where an object-side surface of the solid immersion lens faces the surface of the substrate on which the first and second thin films have been alternately stacked.

The second lens manufacturing method further includes separating the substrate bonded in the bonding.

Still another embodiment of the present disclosure is directed an optical drive apparatus configured as follows.

That is, the optical drive apparatus includes an objective lens including a solid immersion lens having a super-hemispherical or hemispherical shape and having a hyper-lens portion formed in a part of an object-side surface of the solid immersion lens and integrated therewith by alternately stacking a first thin film having a positive dielectric constant and a second thin film having a negative dielectric constant along spherical shapes starting from a spherical shape having a radius Ri around a predetermined reference point Pr set outside the object-side surface of the solid immersion lens to a spherical surface having a radius Ro (Ro>Ri) around the reference point Pr.

The optical drive apparatus further includes a recording/reproduction unit that irradiates an optical recording medium with light via the objective lens to record information on the optical recording medium or reproduce information recorded on the optical recording medium.

The hyper-lens portion, in which a thin film having a positive dielectric constant and a thin film having a negative dielectric constant are alternately stacked, allows light produced by a solid immersion lens portion (the portion other than the hyper-lens portion in the solid immersion lens) and having an NA (NA: numerical aperture) greater than one to propagate, as will be described later.

The hyper-lens portion having the shape described above further allows the size of a microscopic spot of the light produced by the solid immersion lens portion and having an NA greater than one to be reduced by a factor of Ro/Ri, which is the ratio of the radius Ro to the radius Ri.

As described above, the hyper-lens portion not only further reduces the size of the microscopic spot of the light produced by the solid immersion lens portion and having an NA greater than one but also allows the light to propagate to the optical recording medium so that the optical recording medium is irradiated with the light.

As a result, the objective lens according to the embodiment of the present disclosure allows information to be recorded by using a light spot having a diameter smaller than that obtained by a solid immersion lens of related art.

Further, the hyper-lens portion having the shape described above also allows the size of a return light flux from an object to be enlarged by a factor of Ro/Ri, which is the ratio of the radius Ro to the radius Ri. That is, the hyper-lens portion can reduce/enlarge the size of a light flux in a reversible manner.

According to the objective lens of the embodiment of the present disclosure, information can be recorded by using a light spot having a diameter smaller than that obtained by a solid immersion lens (SIL) of related art. That is, the recording density and the recording capacity therefore become higher than those obtained by an objective lens using a SIL of related art.

Further, the hyper-lens portion of the objective lens according to the embodiment of the present disclosure capable of reducing/enlarging the size of a light flux in a reversible manner can also be used to appropriately read a mark (information) recorded by using the microscopic light spot produced by the objective lens according to the embodiment of the present disclosure.

A system using a single optical system common to recording and reproduction can thus be achieved, as in an optical disc system of related art.

### BRIEF DESCRIPTION OF THE DRAWINGS

FIG. 1 describes an objective lens according to an embodiment;

FIG. 2 is an enlarged cross-sectional view of a hyper-lens portion;

FIG. 3 shows the configuration of an objective lens including a separate hyper-lens;

FIG. 4 shows specific calculation results that demonstrate advantageous effects provided by the objective lens according to the embodiment;

FIGS. 5A and 5B describe a first manufacturing method, which is a manufacturing method according to the embodiment;

FIGS. 6A to 6C describe a second manufacturing method, which is another manufacturing method according to the embodiment;

FIG. 7 primarily shows an internal configuration of an optical pickup in an optical drive apparatus according to the embodiment;

FIG. 8 shows a cross-sectional structure of an optical recording medium to and from which information is recorded and reproduced in the embodiment;

FIG. 9 shows an overall internal configuration of an optical drive apparatus according to the embodiment;

FIGS. 10A and 10B describe the field of view of the objective lens according to the embodiment;

FIG. 11 describes the relationship between a gap length and the amount of return light from the objective lens; and

FIG. 12 describes a near-field optical system using a solid immersion lens.

### DETAILED DESCRIPTION

A form for carrying out the present disclosure (hereinafter referred to as an embodiment) will be described below.

The description will be made in the following order.

<1. Objective lens according to an embodiment>

<2. Manufacturing method>
[2-1. First manufacturing method]
[2-2. Second manufacturing method]

<3. Drive apparatus>
[3-1. Configuration of optical pickup]
[3-2. Overall internal configuration of drive apparatus]

<4. Variations>

### <1. Objective Lens According to an Embodiment>

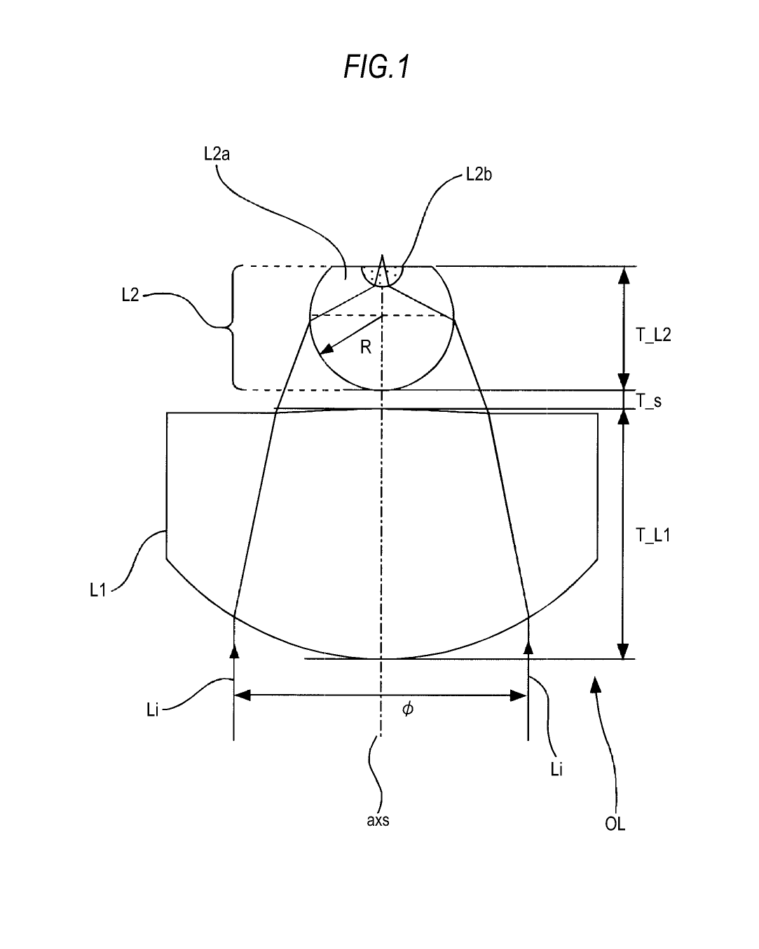

FIG. 1 describes the configuration of an objective lens OL, which is an objective lens according to an embodiment of the present disclosure.

FIG. 1 is a cross-sectional view of the objective lens OL.

FIG. 1 also shows light Li incident on the objective lens OL and an optical axis axs of the incident light Li.

The objective lens OL according to the present embodiment is formed of a group of two lenses, a rear lens L1 and a front lens L2, as shown in FIG. 1.

In this case, a bi-aspheric lens is used as the rear lens L1.

The rear lens L1 converts the incident light Li into convergent light, which is then incident on the front lens L2.

The front lens L2 is formed of a SIL portion (SIL: solid immersion lens) L2a and a hyper-lens portion L2b integrated therewith. In other words, it can be said that the front lens L2 is a solid immersion lens with the hyper-lens portion L2b formed as a part thereof.

In the present example, the SIL (SIL portion L2a) used as the front lens L2 has a super-hemispherical shape, as shown in FIG. 1. Specifically, the SIL portion L2a in the present example is a super-hemispherical SIL having a flat object-side surf ace.

For confirmation purposes, the “object-side” used herein means the side facing an object to be irradiated with light through the objective lens. Since the objective lens OL in the present example is used in a system that records and reproduces information to and from an optical recording medium, the term “object-side” means the side facing a recording surface of the optical recording medium.

The SIL portion L2a as a solid immersion lens is made of a high refractive index material at least having a refractive index greater than one and converts the light incident through the rear lens L1 into near-field light (evanescent light) having a numerical aperture NA greater than one.

In the front lens L2, the hyper-lens portion L2b is formed in an object-side portion of the SIL portion L2a, as shown in FIG. 1. This configuration allows the near-field light produced by the SIL portion L2a to be incident on the hyper-lens portion L2b.

The hyper-lens portion L2b as a whole has a substantially hemispherical shape, as shown in FIG. 1.

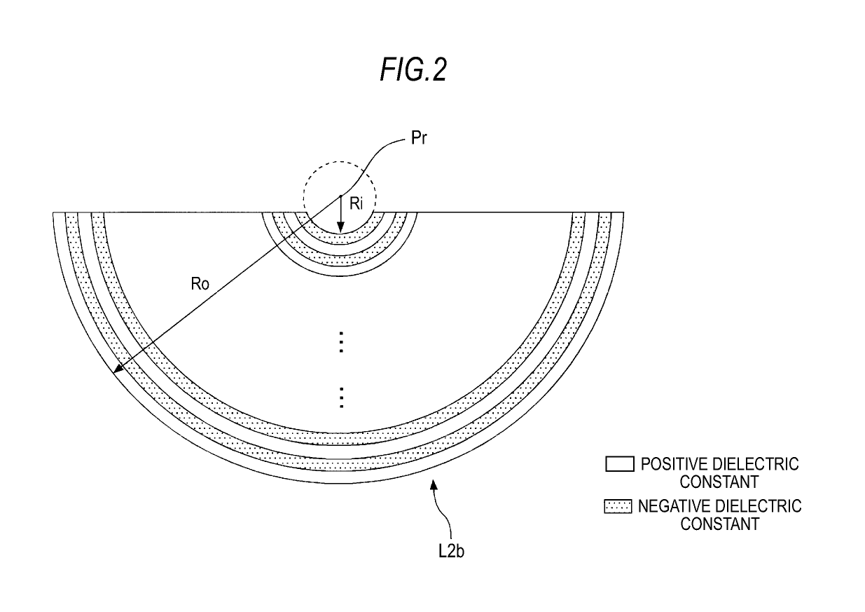

FIG. 2 is an enlarged cross-sectional view of the hyper-lens portion L2b.

The hyper-lens portion L2b has a structure in which a plurality of thin films are stacked, as shown in FIG. 2.

Specifically, the hyper-lens portion L2b has a first thin film having a positive dielectric constant ∈ (∈>0) and a second thin film having a negative dielectric constant ∈ (∈<0) alternately stacked.

A material having a negative dielectric constant ∈ is also called a plasmonic material. Examples of the plasmonic material may include Cu, Ag, Au, and Al.

Examples of the material having a positive dielectric constant ∈ may include SiO₂, SiN, C, glass, polymers, metal oxides, and GaN.

The dielectric constant ∈ changes in accordance with the wavelength λ of light in use. The material of each of the first and second thin films may therefore be so selected in accordance with the wavelength λ that an intended dielectric constant ∈ is obtained.

In the present example, the first thin film is made of Al₂O₃, and the second thin film is made of Ag (the wavelength λ is assumed to be 405 nm in the present example, as will also be described later).

In FIG. 2, the first and second thin films are stacked along spherical surfaces starting from a spherical surface having a radius Ri around a predetermined reference point Pr set outside the object-side surface of the hyper-lens portion L2b (that is, outside the object-side surface of the front lens L2) to a spherical surface having a radius Ro (Ro>Ri) around the reference point Pr. Since the first and second thin films are stacked along spherical surfaces, the resultant stacked films have a dome shape, as shown in FIG. 2. As a result, the hyper-lens portion L2b has an annual-ring-like cross-sectional shape, as shown in FIG. 2.

For confirmation purposes, the hyper-lens portion L2b, which as a whole has a substantially hemispherical shape as described above, therefore has a flat object-side surface except the spherical portion having the radius Ri described above. The reason why the object-side surface of the hyper-lens portion L2b is substantially flat is that it should agree with the flat object-side surface of the SIL portion L2a, with which the hyper-lens portion L2b is integrated.

The total number of stacked first and second thin films may range from 3 to 100,000, specifically, 34 in the present example.

The thickness of each of the first and second thin films may range from 4 to 40 nm, specifically, 10 nm in the present example.

The hyper-lens portion L2b has a structure in which the first thin film (∈>0) and the second thin film (∈<O) are alternately stacked, as described above. This structure allows light having an NA greater than one (near-field light) to propagate in the hyper-lens portion L2b in directions parallel to the direction in which the thin films are stacked. That is, the structure allows the light produced by the SIL portion L2a and having an NA greater than one to propagate and exit toward an object.

Further, according to the stacked structure of the hyper-lens portion L2b described above, when the light having entered through the spherical surface having the radius Ro exits out of the spherical surface having the radius Ri, the size of the light flux (that is, the diameter of the light spot) can be reduced by a factor of Ro/Ri, which is the ratio of the radius Ro to the radius Ri.

The hyper-lens portion L2b, which can provides the advantageous effects described above, not only further reduces the size of the microscopic spot of the light produced by the SIL portion L2a and having an NA greater than one but also allows the light to propagate to an optical recording medium so that the optical recording medium is irradiated with the light.

As a result, the objective lens OL according to the present embodiment allows information to be recorded by using a light spot having a diameter smaller than that obtained by an objective lens using a solid immersion lens of related art. That is, the recording density and hence the recording capacity become higher than those in related art.

Further, the hyper-lens portion L2b having the structure shown in FIG. 2 also allows the size of a return light flux from an object to be enlarged by a factor of Ro/Ri, which is the ratio of the radius Ro to the radius Ri. That is, the hyper-lens portion L2b can reduce/enlarge the size of a light flux in a reversible manner.

The objective lens OL including the hyper-lens portion L2b capable of reducing/enlarging the size of a light flux in a reversible manner can also be used to appropriately read a mark (information) recorded by using the microscopic light spot produced by the objective lens OL.

That is, information can therefore be recorded and reproduced by using a common optical system, as in an optical disc system of related art, such as systems for a CD (compact disc), a DVD (digital versatile disc), and a BD (Blu-ray® disc). In other words, it is not necessary to employ a complicated configuration including two different optical systems for recording and reproducing information.

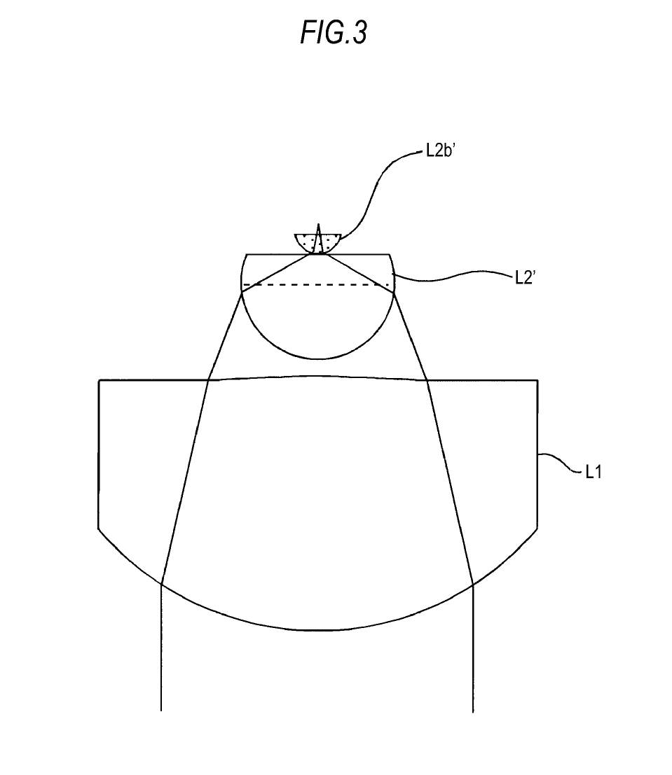

In the present embodiment, the hyper-lens portion L2b is integrated with the SIL portion L2a. To achieve the further reduction in the spot diameter performed by the hyper-lens portion L2b and the reduction/enlargement of the size of a light flux in a reversible manner, it is, for example, alternatively conceivable to employ a configuration in which a front lens L2′, which is a SIL of related art, and a hyper-lens L2b′, which has the same structure as that of the hyper-lens portion L2b, are separately provided, as shown in FIG. 3.

When the front lens L2′ as a SIL and the hyper-lens L2b′ are provided separately from each other, however, the front lens L2′ is in contact with the hyper-lens L2b′ only at a single point but the remaining space therebetween is filled with air. In this configuration, when light is incident through the front lens L2′ on the hyper-lens L2b′, light loss due to reflection disadvantageously occurs. Since the front lens L2′ as a SIL and the hyper-lens L2b′ are made of high refractive index materials, the amount of loss due to reflection is very large.

The problem described above can be effectively solved by employing the configuration of the present embodiment, in which the hyper-lens portion L2b is integrated with a SIL, whereby the efficiency representing how much light is effectively used can be greatly increased.

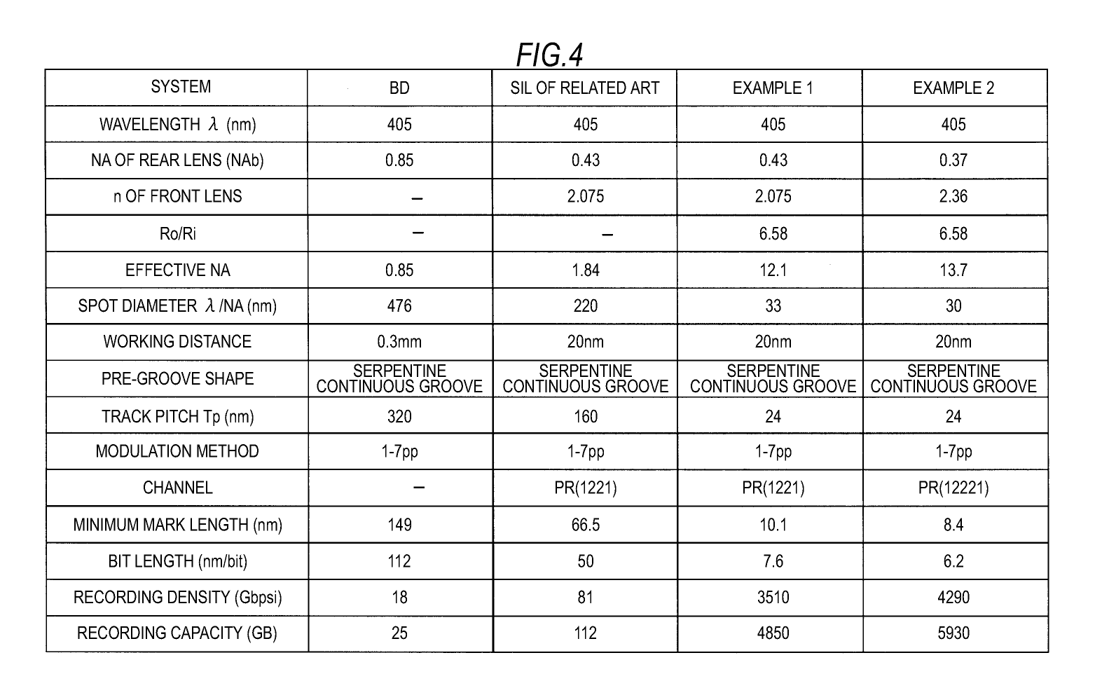

FIG. 4 shows specific calculation results that demonstrate advantageous effects provided by the objective lens OL according to the embodiment described above.

FIG. 4 shows parameters associated with a BD system, a SIL system of related art, and a system using the objective lens OL according to the embodiment (Examples 1 and 2 in FIG. 4). The parameters include the wavelength λ (nm), the NA of the rear lens (NAb), the refractive index of the front lens (n), the reduction/enlargement ratio (Ro/Ri), the effective NA, λ/NA (nm) representing the spot diameter, the working distance (distance to recording medium: gap), the pre-groove shape, the track pitch Tp (nm), the modulation method, and a channel. FIG. 4 also shows calculation results of the minimum mark length (nm), the bit length (nm/bit), the recording density (Gbpsi), and the recording capacity (GB).

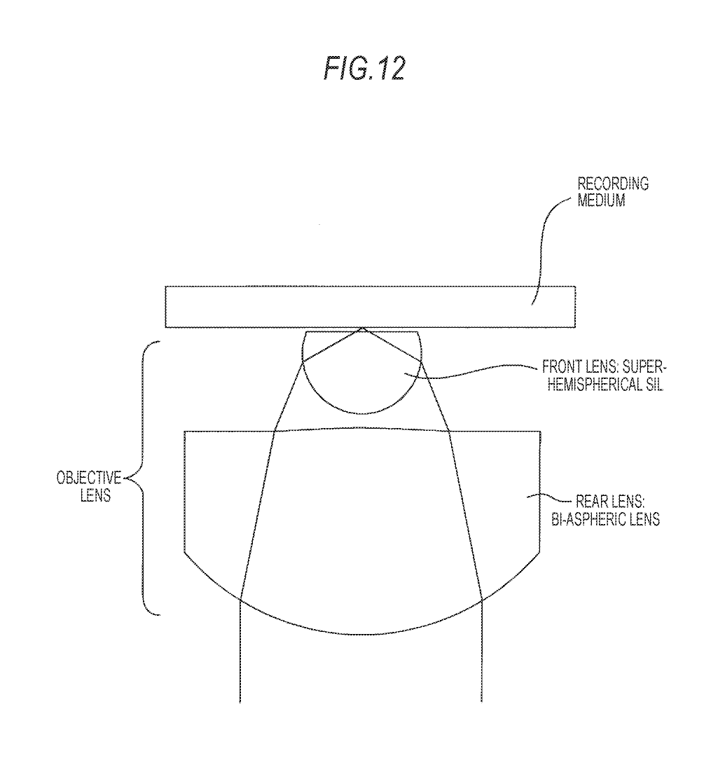

In FIG. 4, the “SIL system of related art” refers to a system using the super-hemispherical solid immersion lens shown in FIG. 12.

Further, the “channel” in FIG. 4 represents the class of employed PR (partial response).

The “recording capacity” refers to that provided when the recording medium under evaluation is a 12-cm disc.

Examples 1 and 2 corresponding to systems according to the embodiment primarily differ from each other in terms of the NA of the rear lens L1 and the refractive index n of the front lens L2.

In the system of Example 1, parameters other than those shown in FIG. 4 include the thickness T_L1 (the length in the direction parallel to the optical axis axs) of the rear lens L1, the thickness T_L2 of the SIL portion L2a, the radius R of the SIL portion L2a, and the space between the rear lens L1 and the front lens L2 (the distance from the apex of the object-side surface of the rear lens L1 to the apex of the super-hemispherical surface of the SIL portion L2a) T_s shown in FIG. 1. These values are set as follows.
T_L1=1.7 mm
T_L2=0.7124 mm
R=0.45 mm
T_s=0.1556 mm

Further, the incident light Li incident on the rear lens L1 is assumed to be collimated light and the diameter thereof φ is set at 2.1 mm.

In FIG. 4, first of all, the wavelength λ is 405 nm, which is common to the BD system, the SIL system of related art, and Examples 1 and 2.

The NA of the rear lens in the BD system is the NA of the objective lens, specifically, 0.85. In the SIL system of related art and Examples 1 and 2, the NA is that of the rear lens L1, specifically, 0.43 in the SIL system of related art and Example 1 and 0.37 in Example 2.

The refractive index n of the front lens is not applicable in the BD system, 2.075 in the SIL system of related art and Example 1, and 2.36 in Example 2.

The reduction/enlargement ratio (Ro/Ri) is 6.58 in Examples 1 and 2 and is not applicable in other systems.

In the present example, the radii Ri and Ro are set at 120 nm and 790 nm, respectively. As a result, Ro/Ri is 6.58.

The effective NA, which is the effective numerical aperture NA of an objective lens, is 0.85 in the BD system and 1.84 in the SIL system of related art. In contrast, the effective NA is 12.1 in Example 1 and 13.7 in Example 2.

For confirmation purposes, the effective NA of the objective lens in the SIL system of related art (super-hemispherical SIL) is determined by the following expression as described above.

NA=n_{SIL}²×sin θi

In contrast, the effective NA of the objective lens OL in Examples 1 and 2 is calculated by the following expression.

NA=n²×NAb×(Ro/Ri)

The spot diameter is 476 nm in the BD system and 220 nm in the SIL system of related art. In contrast, the spot diameter is 33 nm in Example 1 and 30 nm in Example 2.

According to the objective lens OL of the embodiment, the spot diameter can thus be greatly reduced as compared with that in the SIL system of related art.

The working distance is 0.3 mm in the BD system. Since a near-field recoding and reproducing method is used in the SIL system of related art and Examples 1 and 2, the working distance (that is, gap G) is 20 nm.

The pre-groove shape is a serpentine continuous groove (wobbling groove) in all the systems.

The track pitch Tp is 320 nm in the BD system and 160 nm in the SIL system of related art.

In Examples 1 and 2, in which the spot diameter is reduced as described above, the track pitch Tp is 24 nm, which is smaller than the value in the SIL system of related art.

The modulation method is 1-7 pp modulation in all the systems.

The channel is not applicable in the BD system (no PRML decoding) whereas being PR (1, 2, 2, 1) in the SIL system of related art and Example 1. In Example 2, PR (1, 2, 2, 2, 1) is employed.

The minimum mark length is 149 nm in the BD system and 66.5 nm in the SIL system of related art.

In contrast, the minimum mark length can be reduced to 10.1 nm in Example 1 and 8.4 nm in Example 2.

The bit length is 112 nm/bit in the BD system and 50 nm/bit in the SIL system of related art.

In contrast, the bit lengths in Examples 1 and 2 are greatly smaller than that in the SIL system of related art, 7.6 nm/bit in Example 1 and 6.2 nm/bit in Example 2.

The recording density is 18 Gbpsi in the BD system and 81 Gbpsi in the SIL system of related art. In contrast, the recoding density is 3510 Gbpsi in Example 1 and 4290 Gbpsi in Example 2.

The results indicate that the recording density can be improved by a factor of several tens in the embodiment.

The recording capacity is 25 GB in the BD system and 112 GB in the SIL system of related art. In contrast, the recoding capacity is increased to 4850 GB and 5930 GB in Examples 1 and 2, respectively.

As understood from the results, the recording capacity can also be improved by a factor of approximately several tens in the embodiment as compared with that in the SIL system of related art.

### <2. Manufacturing Method>

### [2-1. First Manufacturing Method]

A description will subsequently be made of a method for manufacturing the front lens L2 accommodated in the objective lens OL according to the embodiment described above.

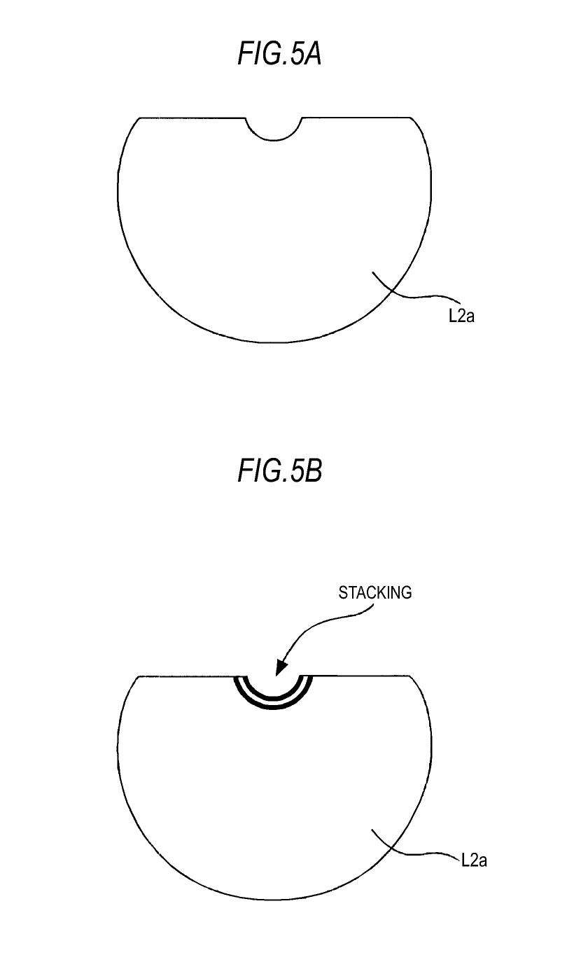

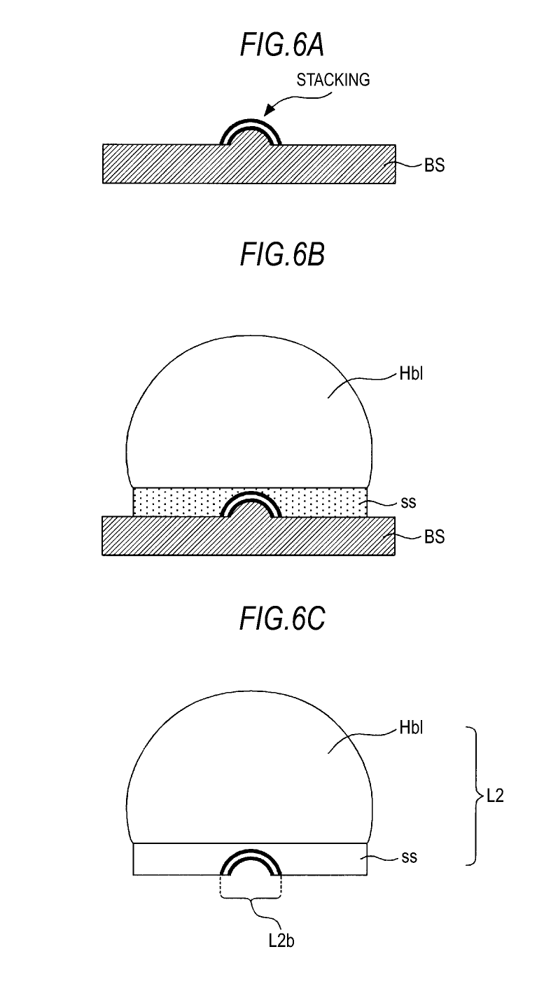

In the following sections, first and second methods for manufacturing the front lens L2 will be described with reference to FIGS. 5A and 5B and FIGS. 6A to 6C, respectively.

The first manufacturing method will first be described with reference to FIGS. 5A and 5B.

In the first manufacturing method, a recess for forming the hyper-lens portion L2b is formed in the object-side surface of a SIL, and then thin films are stacked in the recess to manufacture the dome-shaped front lens L2.

Specifically, the first manufacturing method includes a recess formation step shown in FIG. 5A. In the recess formation step, a substantially hemispherical recess for forming the hyper-lens portion L2b is formed in the flat portion of a super-hemispherical SIL. That is, the recess formation step is a step of producing the SIL portion L2a having the shape shown in FIG. 1.

As will be understood from the description made earlier, the recess is so formed to have the same shape as that of a part of the spherical surface around the predetermined reference point Pr.

To specifically form the recess, HF etching (HF: hydrogen fluoride) or CF₄ etching, which are described in JP-A-8-1810 and other documents, can be used.

After the recess is formed in the recess formation step shown in FIG. 5A, a stacking step shown in FIG. 5B is carried out. In the stacking step, a plurality of first thin films (∈>0) and a plurality of second thin films (∈<0) are alternately stacked in the recess.

As will be understood from the description made earlier, the thin films are stacked along the spherical shape of the recess to form what is called a dome shape. The dome-shaped stacking is so performed that the shape of the object-side surface of the final stacked thin film agrees with the shape of the spherical surface having the predetermined radius Ri set in advance around the predetermined reference point Pr. The reason for this is to obtain a desired enlargement/reduction ratio (Ro/Ri).

To specifically stack the first and second thin films, sputtering, vapor deposition (electron beam vapor deposition, for example), or any other suitable technique can be used.

The number of stacked thin films is three in FIG. 5B for illustration purposes only. The same holds for the following FIGS. 6A to 6C.

### [2-2. Second Manufacturing Method]

The second manufacturing method will subsequently be described with reference to FIGS. 6A to 6C.

The second manufacturing method includes forming the hyper-lens portion L2b by using a substrate on which a substantially hemispherical protrusion is formed, bonding a SIL to the substrate, and separating the substrate to produce the front lens L2.

In the second manufacturing method, a substrate BS having a substantially hemispherical protrusion shown in FIG. 6A is first produced. The protrusion on the substrate BS is so formed that the surface thereof has the same shape as that of a part (substantially hemispherical portion) of the spherical surface having the radius Ri around the predetermined reference point Pr.

The substrate BS is, for example, a quartz substrate.

To produce the substrate BS having the protrusion, a method for manufacturing a microlens array by using RIE (reactive ion dry etching) disclosed in Japanese Patent No. 3,617,846 and other documents can be used.

In the second manufacturing method, a plurality of first thin films (∈>0) and a plurality of second thin films (∈<0) are alternately stacked over the protrusion on the substrate BS. In this case as well, the thin films are stacked along the spherical shape of the protrusion so that the dome-shaped stacking shown in FIG. 2 is performed. The stacking is so performed that the shape of the object-side surface of the final stacked thin film agrees with the shape of the spherical surface having the predetermined radius Ro set in advance around the reference point Pr.

After the thin film stacking step described above is carried out, the bonding step shown in FIG. 6B is carried out. In the bonding step, the surface of the substrate BS on which the protrusion has been formed is set to face the object-side surface (flat portion) of a super-hemispherical solid immersion lens Hbl, and the solid immersion lens Hbl is bonded to the substrate BS with a high refractive index adhesive ss.

Specifically, in the present example, a high refractive index resin is used as the high refractive index adhesive ss, and the space created when the surface of the substrate BS on which the protrusion has been formed faces the object-side surface of the solid immersion lens Hbl is filled with the high refractive index resin. The solid immersion lens Hbl is then boned to the substrate BS by curing the thus filled resin with ultraviolet light.

The refractive index of the high refractive index adhesive ss is desirably close to the refractive index of the solid immersion lens Hbl, or most preferably, the high refractive index adhesive ss has the same refractive index as that of the solid immersion lens Hbl, whereby the amount of reflection-related light loss resulting from the difference in refractive index between the high refractive index adhesive ss and the solid immersion lens Hbl is reduced.

After the solid immersion lens Hbl is bonded to the substrate BS in the bonding step described above, only the substrate BS is separated in the separation step shown in FIG. 6C.

The front lens L2 having the hyper-lens portion L2b formed in a part of the object-side surface is thus produced.

### <3. Drive Apparatus>

### [3-1. Configuration of Optical Pickup]

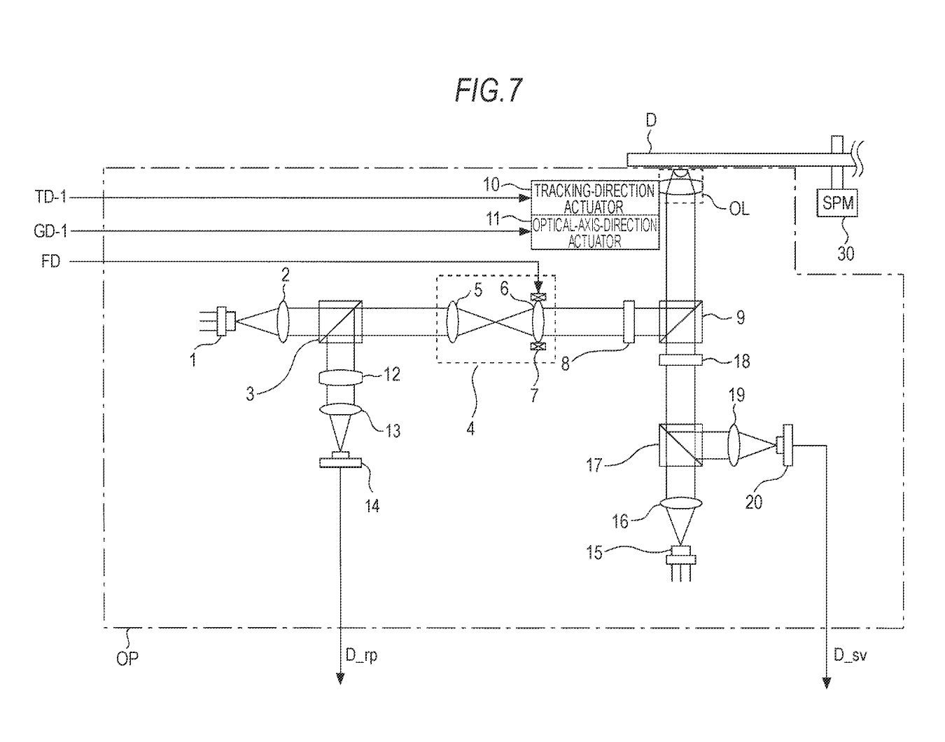

FIG. 7 primarily shows an internal configuration of an optical pickup (optical pickup OP) in an optical drive apparatus as an embodiment including the objective lens OL.

First of all, FIG. 7 shows an optical disc D to and from which the optical drive apparatus according to the embodiment records and reproduces information.

The optical disc D, to and from which information is recorded and reproduced when irradiated with light, is a disc-shaped optical recording medium.

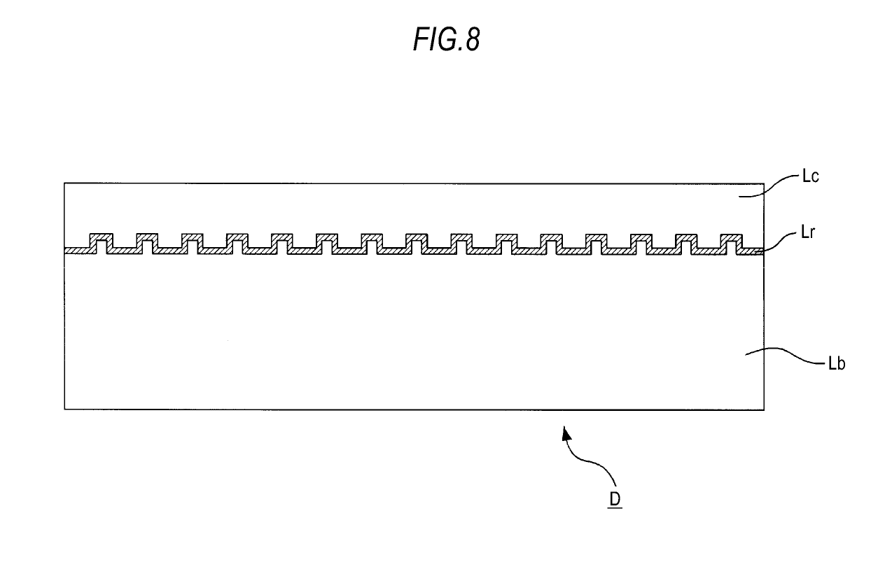

FIG. 8 shows a cross-sectional structure of the optical disc D.

The optical disc D has a cover layer Lc, a recording layer Lr, and a substrate Lb formed in this order, as shown in FIG. 8. Light that exits out of the objective lens OL accommodated in the optical drive apparatus is incident on the cover layer Lc.

The cover layer Lc is provided to protect the recording layer Lr.

The recording layer Lr is formed of a recording film and a reflection film, and a recording mark is formed in the recording film when it is irradiated with laser light in accordance with recording power. In this case, the recording film is made of a phase change material.

The recording layer Lr has pits and projections in the cross-sectional view of FIG. 8 that are produced in association with formation of a guide groove.

Specifically, in this case, a guide groove is formed on the substrate Lb, and when the recording layer Lr is formed on the surface of the substrate Lb on which the guide groove has been formed, the recording layer Lr is given the pits and projections in the cross-sectional view.

In the present example, a wobbling grove is formed as the guide groove, and absolute position information (radial position information and rotational angle information) representing an absolute position on the disc is recorded by using information on the cycle of the serpentine curve of the groove.

The guide groove has a spiral shape (or may be formed of guide grooves having concentric shapes).

The description of the optical pickup OP will be made again with reference to FIG. 7.

In FIG. 7, the optical disc D is rotated by a spindle motor (SPM) 30 shown in FIG. 7. The optical disc D rotated by the spindle motor 30 is irradiated with light through the optical pickup OP so that information is recorded or reproduced to or from the optical disc D.

The optical pickup OP includes an optical system for recoding/reproduction laser light used to record and reproduce information to and from the recording layer Lr and an optical system for gap servo laser light used to perform gap length servo for maintaining the gap G between the objective lens OL and the optical disc D.

As described in JP-A-2010-33688 cited above, the recording/reproduction laser light and the gap servo laser light have wavelength bands different from each other. In the present example, the recording/reproduction laser light has a wavelength of approximately 405 nm, and the gap servo laser light has a wavelength of approximately 650 nm.

First, in the optical system for the recording/reproduction laser light, the recording/reproduction laser light emitted from a recording/reproduction laser 1 is collimated by a collimation lens 2 and then incident on a polarizing beam splitter 3. The polarizing beam splitter 3 is configured to transmit the recording/reproduction laser light emitted from the recording/reproduction laser 1.

The recording/reproduction laser light having passed through the polarizing beam splitter 3 enters a focus mechanism 4 formed of a fixed lens 5, a movable lens 6, and a lens drive unit 7. The focus mechanism 4 adjusts the position where the recording/reproduction laser light is focused.

In the focus mechanism 4, the fixed lens 5 is disposed in a position close to the recording/reproduction laser 1, which is the light source, and the movable lens 6 is disposed in a position away from the recording/reproduction laser 1. The lens drive unit 7 drives the movable lens 6 in the direction parallel to the optical axis of the recording/reproduction laser light.

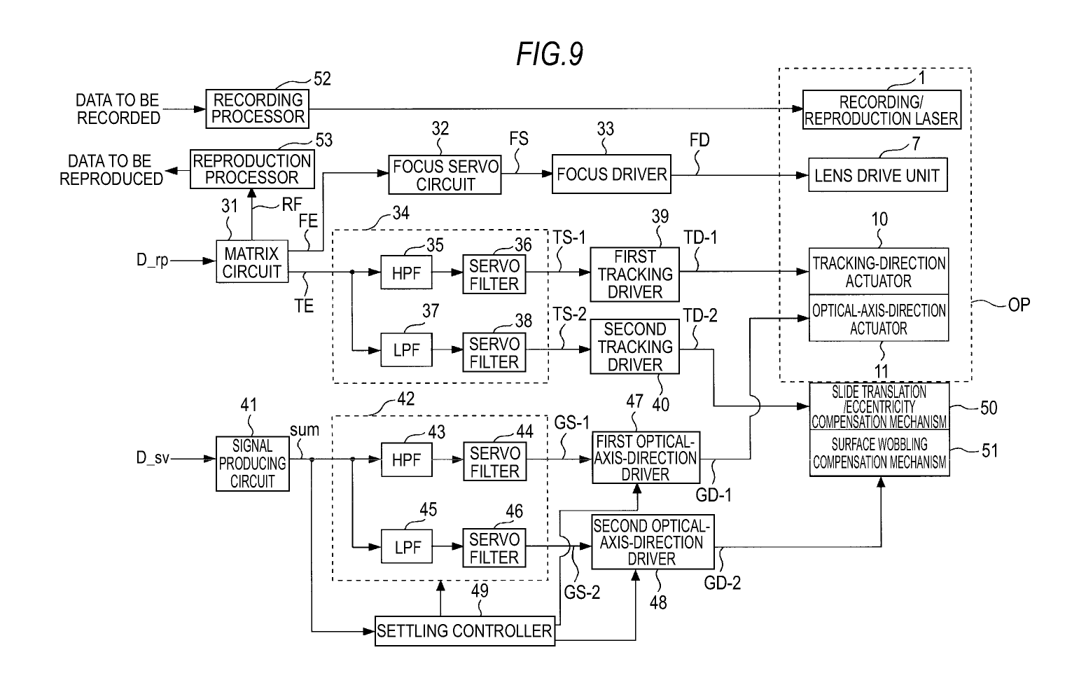

As will be described later, the lens drive unit 7 is driven and controlled by a focus drive signal FD from a focus driver 33 shown in FIG. 9.

The recording/reproduction laser light having passed through the fixed lens 5 and the movable lens 6 in the focus mechanism 4 passes through a quarter-wave plate 8 and enters a dichroic prism 9.

The dichroic prism 9 having a selective reflection surface reflects light having the same wavelength band as that of the recording/reproduction laser light and transmits light having the remaining wavelengths. The recording/reproduction laser light having thus entered the dichroic prism 9 is therefore reflected off the dichroic prism 9.

The recording/reproduction laser light reflected off the dichroic prism 9 passes through the objective lens OL, and the optical disc D is irradiated with the recording/reproduction laser light, as shown in FIG. 7.

To control the objective lens OL, the following actuators are provided: a tracking-direction actuator 10 for displacing the objective lens OL in a tracking direction (radial direction of optical disc D) and an optical-axis-direction actuator 11 for displacing the objective lens OL in the optical axis direction (focusing direction).

In the present example, each of the tracking-direction actuator 10 and the optical-axis-direction actuator 11 is a piezoelectric actuator.

In this case, the objective lens OL is held by the tracking-direction actuator 10, and the tracking-direction actuator 10, which holds the objective lens OL, is held by the optical-axis-direction actuator 11. The objective lens OL can therefore be displaced in the tracking direction and the optical axis direction by driving the tracking-direction actuator 10 and the optical-axis-direction actuator 11.

Alternatively, the objective lens OL may be held by the optical-axis-direction actuator 11, and the optical-axis-direction actuator 11 may be held by the tracking-direction actuator 10. In this case as well, the same effect is, of course, provided.

The tracking-direction actuator 10 is driven based on a first tracking drive signal TD-1 from a first tracking driver 39 shown in FIG. 9.

The optical-axis-direction actuator 11 is driven based on a first optical-axis-direction drive signal GD-1 from a first optical-axis-direction driver 47 shown in FIG. 9.

Now, the description will be made of the action of the optical pickup OP again.

In information reproduction, when the optical disc D is irradiated with the recording/reproduction laser light as described above, the light is reflected off the recording layer Lr. The thus reflected recording/reproduction laser light is guided to the dichroic prism 9 via the objective lens OL and reflected off the dichroic prism 9.

The recording/reproduction laser light reflected off the dichroic prism 9 passes through the quarter-wave plate 8 and the focus mechanism 4 in this order (movable lens 6 and fixed lens 5 in this order) and then enters the polarizing beam splitter 3.

The reflected recording/reproduction laser light having entered the polarizing beam splitter 3 (inward light), which had been affected by the quarter-wave plate 4 when passing therethrough and by the recording layer Lr when reflected thereoff, has a polarization direction rotated by 90 degrees from that of the recording/reproduction laser light that has entered the polarizing beam splitter 3 from the recording/reproduction laser 1 (outward light). As a result, the reflected recording/reproduction laser light having entered the polarizing beam splitter 3 as described above is reflected off the polarizing beam splitter 3.

The recording/reproduction laser light thus reflected off the polarizing beam splitter 3 passes through a cylindrical lens 12 and a focusing lens 13 in this order and is focused on a light receiving surface of a recording/reproduction light receiver 14.

The recording/reproduction light receiver 14 is formed of a plurality of light receiving devices, which are so arranged that an astigmatism-based focus error signal, a tracking error signal (push-pull signal), and an RF signal (reproduction signal) can be produced.

In the present example, light reception signals from the light receiving devices that form the recording/reproduction light receiver 14 are collectively called a light reception signal D_rp.

In the optical pickup OP shown in FIG. 7, the optical system for gap servo laser light includes a gap servo laser 15, a collimation lens 16, a polarizing beam splitter 17, a quarter-wave plate 18, a focusing lens 19, and a gap servo light receiver 20.

Gap servo laser light emitted from the gap servo laser 15 is collimated by the collimation lens 16 and then incident on the polarizing beam splitter 17. The polarizing beam splitter 17 is configured to transmit the gap servo laser light emitted from the gap servo laser 15 (outward light).

The gap servo laser light having passed through the polarizing beam splitter 17 passes through the quarter-wave plate 18 and enters the dichroic prism 9.

Since the dichroic prism 9 reflects light having the same wavelength band as that of the recording/reproduction laser light and transmits light having the remaining wavelengths as described above, the gap servo laser light passes through the dichroic prism 9 and enters the objective lens OL.

When the gap length is too long (when no near-field coupling occurs or the light produced by the objective lens OL does not propagate to the optical disc D), the gap servo laser light is totally reflected off an end surface of the objective lens OL (end surface of hyper-lens portion L2b), in which case, the amount of return light is maximized, which will be described later as well. On the other hand, when the gap length is appropriate (when near-field coupling occurs), the amount of light reflected off the end surface of the objective lens OL decreases accordingly, and the amount of return light also decreases.

Gap length servo is performed by using the change in the amount of gap servo laser light reflected off the end surface of the objective lens OL based on the fact that the amount of light correlates with the gap length.

The gap servo laser light reflected off the end surface of the objective lens OL (inward light) passes through the dichroic prism 9 and then enters the polarizing beam splitter 17 via the quarter-wave plate 18.

The reflected gap servo laser light having entered the polarizing beam splitter 17 as the inward light, which had been affected by the quarter-wave plate 18 when passing therethrough and by the objective lens OL when reflected thereoff, has a polarization direction different from that of the outward light by 90 degrees. The reflected gap servo laser light as the inward light is therefore reflected off the polarizing beam splitter 17.

The gap servo laser light reflected off the polarizing beam splitter 17 passes through the focusing lens 19 and is focused on a light receiving surface of the gap servo light receiver 20.

In the present example, the gap servo light receiver 20 is formed of a plurality of light receiving devices. Light reception signals from the plurality of light receiving devices that form the gap servo light receiver 20 are collectively called a light reception signal D_sv.

### [3-2. Overall Internal Configuration of Drive Apparatus]

FIG. 9 shows an overall internal configuration of the optical drive apparatus according to the embodiment.

It is noted that FIG. 9 shows only a limited portion of the internal configuration of the optical pickup OP. That is, among the components shown in FIG. 7, only the recording/reproduction laser 1, the lens drive unit 7, the tracking-direction actuator 10, and the optical-axis-direction actuator 11 are extracted and illustrated.

Further, the spindle motor 30 is omitted in FIG. 9.

First of all, the optical drive apparatus includes a recording processor 52.

The recording processor 52 receives data to be recorded on the optical disc D (data to be recorded) as an input. The recording processor 52 adds error correcting codes to the inputted data to be recorded, performs predetermined recording modulation coding on the inputted data to be recorded, and other processing thereon to produce a modulated data string to be recorded, which is, for example, a binary data string formed of “0” and “1” and actually recorded on the optical disc D.

The recording processor 52 produces a recording pulse signal corresponding to the modulated data string to be recorded and drives the recording/reproduction laser 1 in the optical pickup OP based on the recording pulse signal so that the recording/reproduction laser 1 emits light based thereon.

The optical drive apparatus further includes a matrix circuit 31 and a reproduction processor 53, which are components for reproducing information recorded on the optical disc D.

The matrix circuit 31 produces a necessary signal based on the light reception signal D_rp from the recording/reproduction light receiver 14 shown in FIG. 7 described above.

Specifically, the matrix circuit 31 produces an RF signal (reproduction signal), a focus error signal FE, and a tracking error signal TE based on the light reception signals or the light reception signal D_rp described above from the plurality of light receiving devices. The RF signal is produced in the form of summation signal, and the focus error signal FE is produced by performing computation based on an astigmatism method. The tracking error signal TE is produced in the form of push-pull signal.

Methods for producing the focus error signal FE and the tracking error signal TE are not limited to those described above, but other suitable methods can be used. For example, the tracking error signal TE can alternatively be produced by using a DPP method (differential push-pull method).

The RF signal produced by the matrix circuit 31 is supplied to the reproduction processor 53.

The reproduction processor 53 performs a variety of processing operations on the RF signal, for example, decodes the recording modulation codes, performs error correction, and performs other reproduction processing for restoring the recorded data described above to produce reproduction data based on which the recorded data described above is reproduced.

The optical drive apparatus further includes a focus servo circuit 32, a focus driver 33, a tracking servo circuit 34, a first tracking driver 39, a second tracking driver 40, and a slide translation/eccentricity compensation mechanism 50, which are provided to achieve focus servo and tracking servo for the recording/reproduction laser light and slide servo for the entire optical pickup OP.

First, the focus servo circuit 32 receives the focus error signal FE produced by the matrix circuit 31.

The focus servo circuit 32 performs servo computation (performs phase compensation and adds loop gain) on the focus error signal FE to produce a focus servo signal FS.

The focus driver 33 produces a focus drive signal FD based on the focus servo signal FS inputted from the focus servo circuit 32 and drives the lens drive unit 7 in the optical pickup OP based on the focus drive signal FD.

The recording/reproduction laser light is thus controlled to be focused on the recording layer Lr.

The slide translation/eccentricity compensation mechanism 50 holds the entire optical pickup OP in a displaceable manner in the tracking direction.

The slide translation/eccentricity compensation mechanism 50 includes a motive power unit that responds quicker than a motor accommodated in a thread mechanism provided in an optical disc system of related art, such as a CD system and a DVD system, and displaces the optical pickup OP not only for slide translation at the time of seeking but also for preventing the lens from being shifted due to disc eccentricity in a period during which the tracking servo is activated.

In the present example, the slide translation/eccentricity compensation mechanism 50 includes a linear motor and is configured to exert a drive force produced by the linear motor to a mechanism that holds the optical pickup OP in a displaceable manner in the tracking direction.

The following several sections explain the reason why the entire optical pickup OP is so driven in the optical drive apparatus according to the present embodiment that disc eccentricity is compensated.

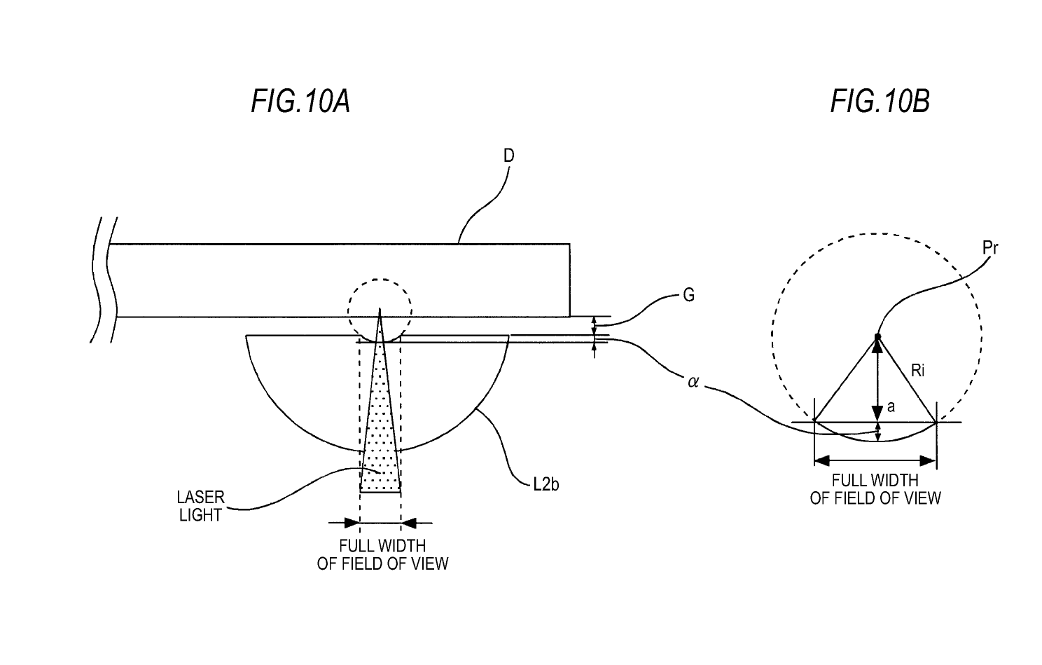

FIGS. 10A and 10B describe the field of view provided of the objective lens OL according to the embodiment.

FIG. 10A shows the positional relationship between the hyper-lens portion L2b formed in the objective lens OL and the optical disc D (positional relationship in the optical axis direction). FIG. 10B is an enlarged view of a portion in FIG. 10A including the gap G between the object-side surface of the hyper-lens portion L2b (that is, the object-side end surface of the objective lens OL) and the optical disc D.

As will be understood by looking at FIG. 10A, the field of view (full width of field of view) of the objective lens OL agrees with the full width of the portion having the spherical shape having the radius of R1 formed on the object side of the hyper-lens portion L2b (the portion is hereinafter referred to as an object-side spherical portion).

As will be understood by looking at FIG. 10B, the full width of the field of view of the objective lens OL, which is equal to the full width of the object-side spherical portion described above, can be calculated by using the radius Ri and a distance α in the optical axis direction between the object-side flat surface of the hyper-lens portion L2b and the apex of the object-side spherical portion.

The calculation can be specifically performed by considering a triangle shown in FIG. 10B and formed by the radius Ri, “Ri-α”, and the half width “a” of the field of view and determining the half width “a” of the field of view from the radius Ri and the distance α.

The radius Ri is set at 120 nm as described above and the distance α is set at 5 nm. In this case, the full width of the field of view is 68 nm because the half width “a” of the field of view is calculated to be 34 nm.

As described above, in a system using the objective lens OL including the hyper-lens portion L2b, the field of view is narrower than those in a BD system and a SIL system of related art.

In view of this point, in the optical drive apparatus according to the embodiment, the optical pickup OP is configured to compensate a disc eccentricity component.

The description of the optical drive apparatus will be made again with reference to FIG. 9.

The tracking servo circuit 34 receives the tracking error signal TE produced by the matrix circuit 31.

The tracking servo circuit 34 includes a first tracking servo signal producing system formed of a high-pass filter (HPF) 35 and a servo filter 36 and a second tracking servo signal producing system formed of a low-pass filter (LPF) 37 and a servo filter 38, as shown in FIG. 9.

The first tracking servo signal producing system corresponds to the tracking-direction actuator 10, which holds the objective lens OL, and the second tracking servo signal producing system corresponds to the slide translation/eccentricity compensation mechanism 50, which holds the optical pickup OP.

In the tracking servo circuit 34, the tracking error signal TE is split and inputted to the high-pass filter 35 and the low-pass filter 37.

The high-pass filter 35 extracts components of the tracking error signal TE that have frequencies higher than or equal to a predetermined cutoff frequency of the high-pass filter 35 and outputs the extracted components to the servo filter 36.

The servo filter 36 performs servo computation on the output signal from the high-pass filter 35 to produce a first tracking servo signal TS-1.

The low-pass filter 37 extracts components of the tracking error signal TE that have frequencies lower than or equal to a predetermined cutoff frequency of the low-pass filter 37 and outputs the extracted components to the servo filter 38.

The servo filter 38 performs servo computation on the output signal from the low-pass filter 37 to produce a second tracking servo signal TS-2.

The first tracking driver 39 drives the tracking-direction actuator 10 by using a first tracking drive signal TD-1 produced based on the first tracking servo signal TS-1.

The second tracking driver 40 drives the slide translation/eccentricity compensation mechanism 50 by using a second tracking drive signal TD-2 produced based on the second tracking servo signal TS-2.

Although not described with reference to the drawings, the tracking servo circuit 34 is configured to deactivate the tracking servo loops, for example, in response to an instruction to set a target address issued from a controller that controls the entire optical drive apparatus and provide the first tracking driver 39 and the second tracking driver 40 with signals for instructing track jumping and seeking.

In the tracking servo circuit 34, the cutoff frequency of the low-pass filter 37 is set at a value greater than or equal to the cycle of disc eccentricity (cycle at which the positional relationship between the light spot position and the target track position changes due to disc eccentricity). The slide translation/eccentricity compensation mechanism 50 can therefore drive the optical pickup OP in such a way that the disc eccentricity is compensated.

That is, the amount of shift of the objective lens OL caused by disc eccentricity can therefore be greatly reduced, and the recording/reproduction laser light can be controlled to fall within the field of view (full width of field of view) shown in FIGS. 10A and 10B. In other words, disc eccentricity will not lead to a situation in which the recording/reproduction laser light shifts out of the field of view and no information can be recorded or reproduced.

The optical drive apparatus further includes a signal producing circuit 41, a gap length servo circuit 42, a first optical-axis-direction driver 47, a second optical-axis-direction driver 48, a settling controller 49, and a surface wobbling compensation mechanism 51, which are components for performing gap length servo.

First, the surface wobbling compensation mechanism 51 holds the slide translation/eccentricity compensation mechanism 50, which holds the optical pickup OP, in a displaceable manner in the optical axis direction (focusing direction).

In the present example, the surface wobbling compensation mechanism 51 also includes a linear motor and hence responds relatively quickly. The surface wobbling compensation mechanism 51 drives the slide translation/eccentricity compensation mechanism 50 in the optical axis direction by driving the linear motor to displace the optical pickup OP in the optical axis direction.

The positional relationship between the surface wobbling compensation mechanism 51 and the slide translation/eccentricity compensation mechanism 50 can be reversed with the functions thereof unchanged, as in the relationship between the tracking-direction actuator 10 and the optical-axis-direction actuator 11 described above.

The signal producing circuit 41 produces a signal that serves as an error signal in the gap length servo based on the gap servo light reception signal D_sv (light reception signals from the plurality of light receiving devices) shown in FIG. 7. Specifically, a summation signal (total light intensity signal) sum is produced.

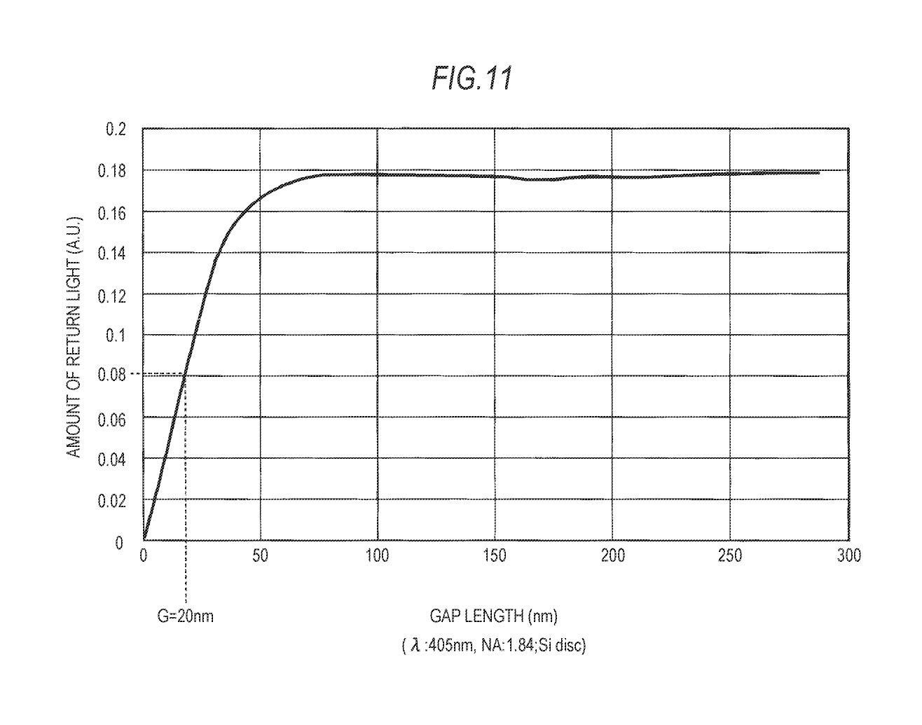

FIG. 11 describes the relationship between the gap length and the amount of return light from the objective lens OL (the amount of return light from the object-side end surface of the hyper-lens portion L2b).

FIG. 11 shows, as an example, the relationship between the gap length and the amount of return light for a silicon (Si) disc, but substantially the same relationship as that shown in FIG. 11 is obtained in the present example, in which the recording layer Lr is made of a phase change material.

As shown in FIG. 11, the amount of return light from the objective lens OL is maximized in the region where the gap length is very long and hence no near-field coupling occurs.

In contrast, in the region where the gap length is approximately 50 nm, which is equal to approximately one-fourth the wavelength, and shorter, near-field coupling occurs and the amount of return light gradually decreases as the gap length shortens.

When the effect of near-field coupling is the first priority, a shorter gap length is more advantageous but could cause collision and friction between the objective lens OL and the optical disc D. To address the problems, the gap length is so set that an appropriate distance to the optical disc D is provided to the extent that near-field coupling occurs.

In consideration of this point, the gap length G (gap G) is set at 20 nm in the present example as described above.

In FIG. 11, a target amount of return light is, for example, approximately 0.08 when the gap length G is set at 20 nm as described above.

To perform the gap length servo, a target amount of return light is determined in advance based on the length of the gap G. The gap length servo is then so performed that the detected amount of return light is equal to the fixed target value thus determined in advance.

The description of the optical drive apparatus will be made again with reference to FIG. 9.

The summation signal sum produced by the signal producing circuit 41 is inputted to the gap length servo circuit 42 and the settling control circuit 49.

The gap length servo circuit 42 includes a first gap length servo signal producing system formed of a high-pass filter 43 and a servo filter 44 and a second gap length servo signal producing system formed of a low-pass filter 45 and a servo filter 46.

The first gap length servo signal producing system corresponds to the optical-axis-direction actuator 11, and the second gap length servo signal producing system corresponds to the surface wobbling compensation mechanism 51.

The high-pass filter 43 receives the summation signal sum as an input, extracts components of the summation signal sum that have frequencies higher than or equal to a predetermined cutoff frequency of the high-pass filter 43, and outputs the extracted components to the servo filter 44.

The servo filter 44 performs servo computation on the output signal from the high-pass filter 43 to produce a first gap length servo signal GS-1.

The low-pass filter 45 receives the summation signal sum as an input, extracts components of the summation signal sum that have frequencies lower than or equal to a predetermined cutoff frequency of the low-pass filter 45, and outputs the extracted components to the servo filter 46.

The servo filter 46 performs servo computation on the output signal from the low-pass filter 45 to produce a second gap length servo signal GS-2.

In the gap length servo circuit 42, a target value of the summation signal sum is determined and set in advance based on the length of the gap G (that is, the value of the summation signal sum for the length of the gap G), and the servo filters 44 and 46 produce the gap length servo signals GS-1 and GS-2 in the servo computation in such a way that the summation signal sum approaches the target value.

The first optical-axis-direction driver 47 drives the optical-axis-direction actuator 11 by using a first optical-axis-direction drive signal GD-1 produced based on the first gap length servo signal GS-1.

The second optical-axis-direction driver 48 drives the surface wobbling compensation mechanism 51 by using a second optical-axis-direction drive signal GD-2 produced based on the second gap length servo signal GS-2.

In the gap length servo circuit 42 described above, the cutoff frequency of the low-pass filter 45 is set at a value greater than or equal to the cycle of disc wobbling. The surface wobbling compensation mechanism 51 can therefore displace the optical pickup OP in such a way that the disc wobbling is compensated.

Driving the entire optical pickup OP to compensate surface wobbling this way prevents the objective lens OL from colliding with the optical disc D.

The settling controller 49 performs settling control in the gap length servo.

In the settling controller 49, a target value of the summation signal sum is determined and set in advance based on the length of the gap G (the value of the summation signal sum for the length of the gap G). The settling controller 49 performs the settling control in the gap length servo based on the thus set target value of the summation signal sum as follows.

First, with the gap length servo deactivated, the difference between the actual value of the summation signal sum inputted from the signal producing circuit 41 and the target value is calculated. It is then judged whether or not the difference falls within a settling range set in advance. When the judgment shows that the difference does not fall within the settling range, a settling waveform according to the difference (signal for changing the summation signal sum in such a way that the difference decreases) is produced and provided to the first optical-axis-direction driver 47 and the second optical-axis-direction driver 48. The value of the summation signal sum can thus be controlled to fall within the settling range.

After the difference falls within the settling range, an instruction is so issued to the gap length servo circuit 42 that the servo loops (both the first and second gap length servo signal producing systems) are activated. The settling control is thus completed.

According to the optical drive apparatus described above, information can be recorded on the optical disc D by using the objective lens OL at a recording density higher than that in related art, whereby the recording capacity of the optical disc D can be increased. At the same time, information recorded at the high recording density can be reproduced by using the objective lens OL.

### <4. Variations>

The embodiment of the present disclosure has been described above, but the present disclosure should not be limited to the specific example described above.

The above description has been made of the case where the hyper-lens portion L2b as a whole has a substantially hemispherical shape (a shape smaller than a hemisphere), but the hyper-lens portion L2b may, for example, have a hemispherical shape.

Further, the above description has been made of the case where the SIL portion L2a is a solid immersion lens having a super-hemispherical shape. Alternatively, a solid immersion lens having a hemispherical shape can be used.

Moreover, the above description has been made of the case where an optical recording medium to and from which information is recorded and reproduced includes a recording layer made of a phase change material. The present disclosure is also suitably applicable to a case where the optical recording medium includes a recording layer made of a material other than phase change materials.

The present disclosure is also suitably applicable to a case where an optical recording medium is what is called a bit-patterned medium disclosed in JP-A-2006-73087 and other documents.

Further, the above description has been made of the case where the objective lens according to the embodiment of the present disclosure is used in a system in which information is recorded and reproduced to and from an optical recording medium. The objective lens according to the embodiment of the present disclosure is also suitably used with an optical microscope and other applications other than optical recording medium-based recording/reproduction systems.

The present disclosure contains subject matter related to that disclosed in Japanese Priority Patent Application JP 2010-187992 filed in the Japan Patent Office on Aug. 25, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An objective lens comprising:
a solid immersion lens having a super-hemispherical or hemispherical shape,
wherein a hyper-lens portion is formed in a part of an object-side surface of the solid immersion lens and integrated therewith by alternately stacking a first thin film having a positive dielectric constant and a second thin film having a negative dielectric constant along spherical shapes starting from a spherical shape having a radius Ri around a predetermined reference point Pr set outside the object-side surface of the solid immersion lens to a spherical surface having a radius Ro (Ro>Ri) around the reference point Pr.

2. The objective lens according to claim 1,
wherein the first thin film is made of one of SiO₂, SiN, C, glass, a polymer, a metal oxide, and GaN.

3. The objective lens according to claim 1,
wherein the second thin film is made of one of Cu, Ag, Au, and Al.

4. The objective lens according to claim 1,
wherein the first thin film is made of Al₂O₃ and the second thin film is made of Ag.

5. The objective lens according to claim 1,
further comprising a rear lens that allows convergent light to be incident on the solid immersion lens through a surface facing away from the object-side surface thereof.

6. A lens manufacturing method comprising:
forming a recess in an object-side surface of a solid immersion lens having a super-hemispherical or hemispherical shape, the recess having the same shape as that of a part of a spherical surface having a predetermined radius Ro; and
alternately stacking a first thin film having a positive dielectric constant and a second thin film having a negative dielectric constant in the recess formed in the forming along the shape of the recess.

7. A lens manufacturing method comprising:
preparing a substrate having a protrusion formed thereon, the protrusion having the same surface shape as that of a part of a spherical surface having a predetermined radius Ri;
alternately stacking a first thin film having a positive dielectric constant and a second thin film having a negative dielectric constant over the protrusion along the shape thereof;
bonding a solid immersion lens having a super-hemispherical or hemispherical shape to the substrate with a high refractive index adhesive in a state where an object-side surface of the solid immersion lens faces the surface of the substrate on which the first and second thin films have been alternately stacked; and
separating the substrate bonded in the bonding.

8. An optical drive apparatus comprising:
an objective lens including a solid immersion lens having a super-hemispherical or hemispherical shape and having a hyper-lens portion formed in a part of an object-side surface of the solid immersion lens and integrated therewith by alternately stacking a first thin film having a positive dielectric constant and a second thin film having a negative dielectric constant along spherical shapes starting from a spherical shape having a radius Ri around a predetermined reference point Pr set outside the object-side surface of the solid immersion lens to a spherical surface having a radius Ro (Ro>Ri) around the reference point Pr; and
a recording/reproduction unit that irradiates an optical recording medium with light via the objective lens to record information on the optical recording medium or reproduce information recorded on the optical recording medium.
